(19) United States
(12) Patent Application Publication
(10) Pub. No.: US 2024/0414351 A1
(43) Pub. Date: Dec. 12, 2024

(54) AI INFERENCE SYSTEM

(71) Applicant: Nippon Telegraph and Telephone Corporation, Tokyo (JP)

(72) Inventors: Kenji Tanaka, Tokyo (JP); Yuki Arikawa, Tokyo (JP); Tsuyoshi Ito, Tokyo (JP); Naoki Miura, Tokyo (JP); Takeshi Sakamoto, Tokyo (JP)

(21) Appl. No.: 18/698,307

(22) PCT Filed: Nov. 22, 2021
(86) PCT No.: PCT/JP2021/042763

§ 371 Date: Apr. 3, 2024

(51) Int. Cl. H04N 19/149; H04N 19/172

(52) U.S. Cl. CPC H04N 19/149; H04N 19/172

(57) ABSTRACT

AI inference system includes an encoder circuit that encodes an image captured by a camera, a decoder circuit that decodes the image, a first inference processing unit that executes first inference processing on the decoded image for each frame, a second inference processing unit that executes second inference processing with higher accuracy than the first inference only for frames of an image whose confidence value of the first inference exceeds a predetermined threshold, and a frame rate control unit that reduces frame rates of the encoder circuit and the decoder circuit from an initial value to a low speed value when the confidence value is equal to or less than the predetermined threshold.

### CROSS-REFERENCE TO RELATED APPLICATIONS

This application is a national phase entry of PCT Application No. PCT/JP2021/042763, filed on Nov. 22, 2021, which application is hereby incorporated herein by reference.

### TECHNICAL FIELD

The present invention relates to an event-driven AI inference system that infers an image captured by a camera only during a time when an event occurs.

### BACKGROUND

Applying artificial intelligence (AI) inference to a moving image acquired by a camera is being considered. It is known that the amount of calculation and the amount of memory required for AI inference increase as the inference accuracy increases. Therefore, a method of transmitting an encoded moving image from a camera or the like and inferring the moving image after decoding in a server or the like is generally used.

However, there are few cases of use in which inference is required for all frames of a moving image acquired by a camera. The reason for this is that, for example, a security camera is required to perform inference only when a person is shown in the frame. That is, it is wasteful to perform inference when no person is shown in the frame. Therefore, event-driven inference has been proposed in which the inference is performed only during the time when an event occurs (NPL 1).

In the event-driven inference, light-weight and low-cost inference is applied to a frame after decoding, and it is determined whether or not highly accurate inference is required. In order to determine execution of highly accurate inference, it is general to use the confidence for the predicted class (hereinafter referred to as confidence), and if the confidence is high, highly accurate inference is executed. The confidence is a value indicating the degree of probability that a neural network (NN) model determines its own output to be correct (NPL 2).

For example, in the case of the above-mentioned security camera, frames of an image acquired by a camera 100 and encoded by an encoder circuit 101 are decoded by a decoder circuit 102 on a server side, for example, as shown in FIG. 6. Then, a first inference processing unit 103 executes person detection inference on the frames of the decoded image, and a second inference processing unit 104 executes face recognition inference as to whether or not the person is a suspicious person only for the frame whose confidence is equal to or higher than a fixed level. Such two-stage inference is called multi-layer inference.

The event-driven multi-layer inference is a technique for reducing the time required for executing the highly accurate inference and reducing the total cost by performing the first-layer inference using a low-cost model. In event-driven multi-layer inference, as a result of the first-layer inference, the second-layer inference may not be performed, but the stream delivery from the camera is always operating, and there is a problem that the cost of encoding/decoding cannot be reduced.

### CITATION LIST

### Non Patent Literature

NPL 1-Takeharu Eda et al., “Highly Efficient Event-Driven Inference Supporting AI Services in the IOWN Era,” NTT Technical Journal, December 2020
NPL 2-“person-detection-retail-0002,” Intel, 2018, <https://docs.openvinotoolkit.org/2018_R5/person-detection-retail-0002.html>

### SUMMARY

### Technical Problem

Embodiments of the present invention have been made to solve the above problem, and an object of embodiments of the present invention is to provide an AI inference system capable of reducing power consumption as compared with the conventional system.

### Solution to Problem

An AI inference system according to embodiments of the present invention includes: an encoder circuit configured to encode an image captured by a camera; a decoder circuit configured to decode the image encoded by the encoder circuit; a first inference processing unit configured to execute first inference processing on the image decoded by the decoder circuit for each frame; a second inference processing unit configured to receive a confidence value of the first inference from the first inference processing unit and to execute second inference processing with higher accuracy than the first inference only for frames of an image whose confidence value exceeds a predetermined threshold value; and a frame rate control unit configured to reduce a frame rate of each of the encoder circuit and the decoder circuit from an initial value to a low speed value when the confidence value is equal to or less than the threshold value.

Further, in one configuration example of the AI inference system according to embodiments of the present invention, the encoder circuit and the decoder circuit are provided for each camera, and the frame rate control unit is configured to reduce the frame rate of each of the encoder circuit and the decoder circuit corresponding to a camera that outputs an image whose confidence value is equal to or less than the threshold value among a plurality of cameras from an initial value to a low speed value.

Further, in one configuration example of the AI inference system according to embodiments of the present invention, the encoder circuit and the decoder circuit are provided for each camera, and the frame rate control unit is configured to, when at least one first camera among a plurality of cameras outputs an image whose confidence value exceeds the threshold value, leave the frame rate of each of the encoder circuit and the decoder circuit corresponding to a second camera that is in a predetermined positional relationship with the first camera at the initial value, and to, when a third camera that is not in a predetermined positional relationship with the first camera outputs an image whose confidence value is equal to or less than the threshold value, reduce the frame rate of each of the encoder circuit and the decoder circuit corresponding to the third camera to the low speed value.

### Advantageous Effects

According to embodiments of the present invention, since the frame rate of each of the encoder circuit and the decoder circuit is reduced from the initial value to the low speed value when the confidence value of the first inference is equal to or less than the threshold value, power consumption can be reduced as compared with conventional event-driven multi-layer inference.

### BRIEF DESCRIPTION OF THE DRAWINGS

FIG. 1 is a block diagram showing a configuration of an AI inference system according to an embodiment of the present invention.

FIG. 2 is a flowchart illustrating operations of an encoder circuit, a decoder circuit, a first inference processing unit, and a second inference processing unit of the AI inference system according to the embodiment of the present invention.

FIG. 3 is a flowchart illustrating an operation of a frame rate control unit of the AI inference system according to the embodiment of the present invention.

FIG. 4 is a block diagram showing another configuration of the AI inference system according to the embodiment of the present invention.

FIG. 5 is a block diagram showing a configuration example of a computer that implements the AI inference system according to the embodiment of the present invention.

FIG. 6 is a diagram illustrating event-driven multi-layer inference.

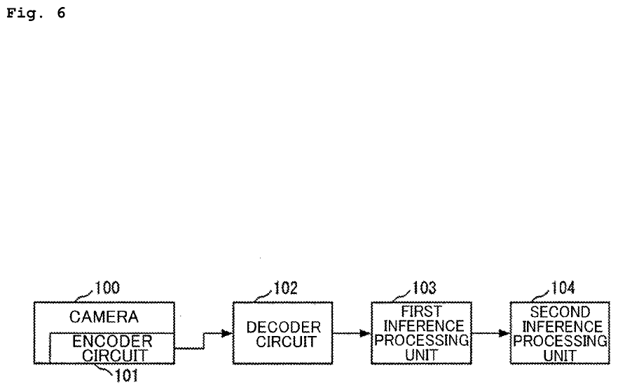

### DETAILED DESCRIPTION OF ILLUSTRATIVE EMBODIMENTS

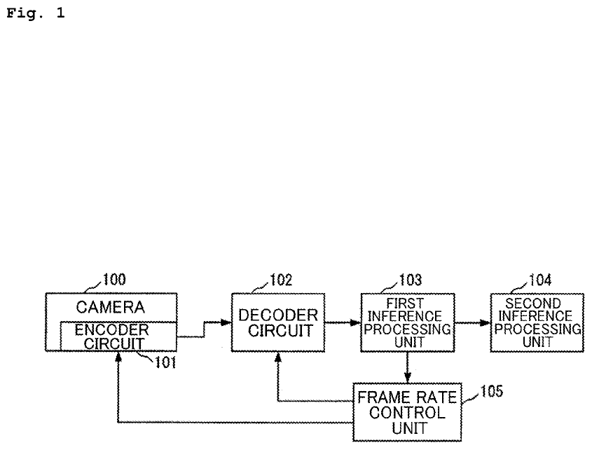

Hereinafter, embodiments of the present invention will be described with reference to the drawings. FIG. 1 is a block diagram showing a configuration of an AI inference system according to an embodiment of the present invention. The AI inference system includes a monitoring camera 100, a decoder circuit 102 that decodes an image encoded by an encoder circuit 101 of the monitoring camera 100, a first inference processing unit 103 that executes inference processing for person detection on frames of the decoded image, a second inference processing unit 104 that receives a confidence value of inference by the first inference processing unit 103 from the first inference processing unit 103 and executes person face recognition inference processing only for frames of an image whose confidence value exceeds a predetermined threshold value, and a frame rate control unit 105 that lowers a frame rate of each of the encoder circuit 101 and the decoder circuit 102 when the confidence value output by the first inference processing unit 103 is equal to or less than the threshold value.

The decoder circuit 102, the first inference processing unit 103, the second inference processing unit 104, and the frame rate control unit 105 are provided inside, for example, a server device located at a position away from the monitoring camera 100.

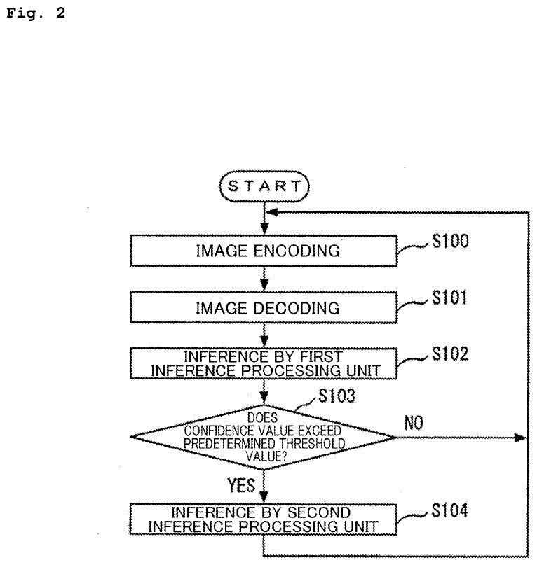

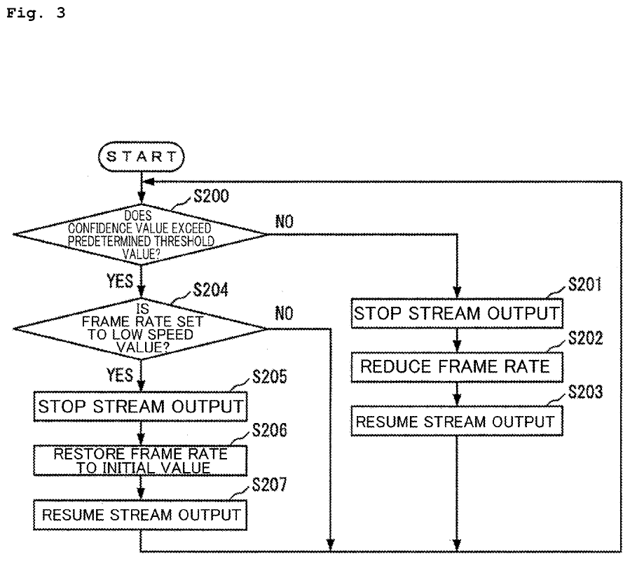

FIG. 2 is a flowchart illustrating operations of the encoder circuit 101, the decoder circuit 102, the first inference processing unit 103, and the second inference processing unit 104, and FIG. 3 is a flowchart illustrating an operation of the frame rate control unit 105.

The encoder circuit 101 encodes an image captured by the monitoring camera 100 (step S100 in FIG. 2).

The decoder circuit 102 decodes the image encoded by the encoder circuit 101 (step S101 in FIG. 2).

The first inference processing unit 103 executes inference processing for person detection on the decoded image for each frame of the image (step S102 in FIG. 2).

When a confidence value output from the first inference processing unit 103 exceeds a predetermined threshold value (YES in step S103 in FIG. 2), the second inference processing unit 104 executes face recognition inference processing of a person present in the frame for the frame whose confidence value exceeds the threshold value (step S104 in FIG. 2).

The encoder circuit 101, the decoder circuit 102, the first inference processing unit 103, and the second inference processing unit 104 execute the processing of steps S100 to S104 for each frame.

On the other hand, when the confidence value output from the first inference processing unit 103 is equal to or less than the threshold value (NO in step S200 in FIG. 3), the frame rate control unit 105 temporarily stops stream output from the encoder circuit 101 and the decoder circuit 102 (step S201 in FIG. 3).

Subsequently, the frame rate control unit 105 accesses the respective clock generation circuits of the encoder circuit 101 and the decoder circuit 102, and rewrites the clock frequency value set in the register of the clock generation circuit to reduce the frame rate of each of the encoder circuit 101 and the decoder circuit 102 from an initial value to a predetermined low speed value (step S202 in FIG. 3).

Then, the frame rate control unit 105 resets the encoder circuit 101 and the decoder circuit 102 to resume the stream output (step S203 in FIG. 3).

Thus, encoding and decoding are performed at a low frame rate from a frame next to a frame whose confidence value becomes equal to or less than the threshold value.

Further, when the confidence value output from the first inference processing unit 103 exceeds the threshold value (YES in step S200), the frame rate control unit 105 temporarily stops stream output from the encoder circuit 101 and the decoder circuit 102 (step S205 in FIG. 3) when the frame rate of each of the encoder circuit 101 and the decoder circuit 102 is set to the low speed value (YES in step S204 in FIG. 3).

Subsequently, the frame rate control unit 105 accesses the respective clock generation circuits of the encoder circuit 101 and the decoder circuit 102, and rewrites the clock frequency value set in the register of the clock generation circuit to restore the frame rate of each of the encoder circuit 101 and the decoder circuit 102 from the low speed value to the initial value (step S206 in FIG. 3).

Then, the frame rate control unit 105 resets the encoder circuit 101 and the decoder circuit 102 to resume the stream output (step S207 in FIG. 3).

Thus, when the confidence value becomes larger than the threshold value after the confidence value becomes equal to or less than the threshold value, encoding and decoding are performed at a normal frame rate from a frame next to a frame whose confidence value becomes equal to or less than the threshold value. The frame rate control unit 105 executes the processing of steps S200 to S207 for each frame.

As described above, in the present embodiment, when the confidence value of the inference by the first inference processing unit 103 is equal to or less than the threshold value, the highly accurate inference by the second inference processing unit 104 is stopped, and at the same time, the frame rates of the encoder circuit 101 and the decoder circuit 102 are reduced. Therefore, the power consumption can be further reduced as compared with the conventional event-driven multi-layer inference.

Since the frame rate of the monitoring camera 100 is at most about 60 frame per second (FPS), there is an interval of about 16.6 milliseconds between frames. Therefore, if the processing of steps S200 to S207 is completed within this interval, frame loss will not occur. When the frame rate is lowered, the cost (for example, dynamic random access memory (DRAM) access) required for data transfer in the encoder circuit 101 and the decoder circuit 102 is reduced, thereby reducing power consumption.

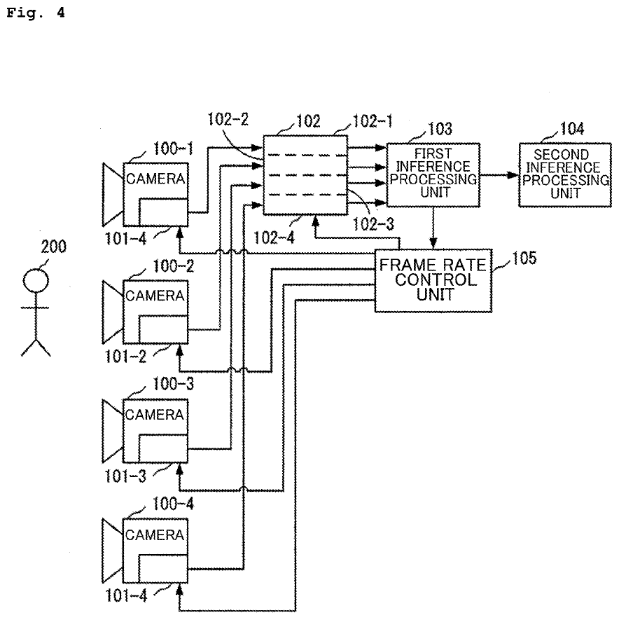

As shown in the example of FIG. 4, in a use case or the like in which a plurality of monitoring cameras 100-1 to 100-4 are connected to the AI inference system, the processing of FIG. 2 and FIG. 3 may be performed for each of the monitoring cameras 100-1 to 100-4, and frame rates of encoder circuits 101-1 to 101-4 and decoder circuits 102-1 to 102-4 may be individually changed for each of the monitoring cameras 100-1 to 100-4. In the example of FIG. 4, the encoder circuits 101-1 to 101-4 and the decoder circuits 102-1 to 102-4 are provided for each of the monitoring cameras 100-1 to 100-4.

Further, in the configuration shown in FIG. 4, when the confidence value of inference exceeds a threshold value for the image of at least one camera among the respective monitoring cameras 100-1 to 100-4, the frame rate control unit 105 not only leaves a frame rate of each of the encoder circuit 101 and the decoder circuit 102 corresponding to a camera that outputs the image whose confidence value exceeds the threshold value at an initial value, but also leaves a frame rate of each of the encoder circuit 101 and the decoder circuit 102 corresponding to a camera that is in a predetermined positional relationship with the camera at an initial value. In addition, the frame rate control unit 105 sets the frame rate of each of the corresponding encoder circuit 101 and decoder circuit 102 to a low speed value for a camera that is not in a predetermined positional relationship with a camera that outputs an image whose confidence value exceeds the threshold value and that outputs an image whose confidence value is equal to or less than the threshold value.

For example, in the example shown in FIG. 4, it is assumed that the confidence of inference for the image output from the monitoring camera 100-2 closest to a person 200 has the highest value. At this time, the frame rate control unit 105 leaves the frame rate of each of the encoder circuit 101-2 and the decoder circuit 102-2 corresponding to the monitoring camera 100-2 that outputs an image whose confidence value exceeds the threshold value at the initial value.

Further, the frame rate control unit 105 leaves the frame rates of the corresponding encoder circuits 101-1 and 101-3 and decoder circuits 102-1 and 102-3 at their initial values regardless of the confidence of inference for the monitoring cameras 100-1 and 100-3 installed within a range of a predetermined distance from the monitoring camera 100-2.

In addition, the frame rate control unit 105 sets the frame rate of each of the encoder circuit 101-4 and the decoder circuit 102-4 corresponding to the monitoring camera 100-4 that is installed outside a range of a predetermined distance from the monitoring camera 100-2 and that outputs an image whose confidence value is equal to or less than the threshold value to a low speed value. Also, the frame rate control unit 105 leaves the frame rates of the corresponding encoder circuit 101 and decoder circuit 102 at initial values for the monitoring camera that outputs an image whose confidence value exceeds the threshold value even when the monitoring camera is installed outside a range of a predetermined distance from the monitoring camera 100-2.

Information indicating the positional relationship of the respective monitoring cameras 100-1 to 100-4 is set in the frame rate control unit 105 in advance.

Thus, the power consumption of the whole AI inference system can be optimized by changing the frame rate according to the positional relationship of the respective monitoring cameras 100-1 to 100-4.

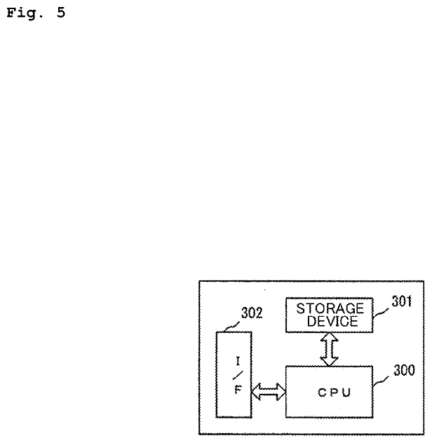

The first inference processing unit 103, the second inference processing unit 104, and the frame rate control unit 105 described in the present embodiment can be implemented by a computer having a central processing unit (CPU), a storage device, and an interface with the outside, and a program that controls these hardware resources. FIG. 5 shows a configuration example of this computer.

The computer includes a CPU 300, a storage device 301, and an interface device (I/F) 302. The encoder circuits 101-1 to 101-4, the decoder circuit 102, and the like are connected to the I/F 302. In such a computer, a program for implementing the method according to embodiments of the present invention is stored in the storage device 301. The CPU 300 executes the processing described in the present embodiment according to the program stored in the storage device 301.

### INDUSTRIAL APPLICABILITY

Embodiments of the present invention can be applied to techniques for improving the efficiency of AI inference.

### REFERENCE SIGNS LIST

100, 100-1 to 100-4 Monitoring camera
101, 101-1 to 101-4 Encoder circuit
102, 102-1 to 102-4 Decoder circuit
103 First inference processing unit
104 Second inference processing unit
105 Frame rate control unit

1.-3. (canceled)

4. An AI inference system comprising:
an encoder circuit configured to encode an image captured by a camera to generate an encoded image;
a decoder circuit configured to decode the encoded image to generate a decoded image;
a storage device comprising instructions; and
one or more processors in communication with the storage device, wherein the one or more processors execute the instructions to:
execute first inference processing on each frame of the decoded image;
generate a respective confidence value for each frame of the decoded image based on the first inference processing;
for each frame of the decoded image, in response to the respective confidence value of a corresponding frame of the decoded image exceeding a predetermined threshold, execute second inference processing with higher accuracy than the first inference on the corresponding frame of the decoded image; and
in response to the respective confidence value of each frame of the decoded image being equal to or less than the predetermined threshold, reduce a frame rate of each of the encoder circuit and the decoder circuit from an initial value to a low speed value.

5. The AI inference system according to claim 4, wherein the camera is one of a plurality of cameras, the encoder circuit is one of a plurality of encoder circuits, the decoder circuit is one of a plurality of decoder circuits, and each of the plurality of encoder circuits and each of the plurality of decoder circuits corresponds to one of the plurality of cameras.

6. The AI inference system according to claim 5, wherein the one or more processors execute the instructions to further:
in response to a first camera of a plurality of cameras outputting an image whose confidence value based on the first inference processing is equal to or less than the predetermined threshold, reduce a frame rate of each of a first encoder circuit of the plurality of encoder circuits and a first decoder circuit of the plurality of decoder circuits corresponding to the first camera from an initial value to a low speed value.

7. The AI inference system according to claim 6, wherein the one or more processors execute the instructions to further:
in response to at least the first camera outputting an image whose confidence value based on the first inference processing exceeds the predetermined threshold, maintain a frame rate of each of a second encoder circuit of the plurality of encoder circuits and a second decoder circuit of the plurality of the decoder circuits at an initial value, wherein the second encoder circuit and the second decoder circuit correspond to a second camera of the plurality of cameras, and wherein the second camera is in a predetermined positional relationship with the first camera.

8. The AI inference system according to claim 7, wherein the one or more processors execute the instructions to further:
in response to a third camera of the plurality of cameras outputting an image whose confidence value based on the first inference processing is equal to or less than the predetermined threshold and the first camera outputting the image based on the first inference processing whose confidence value exceeds the predetermined threshold, reduce a frame rate of each of a third encoder circuit of the plurality of encoder circuits and a fourth decoder circuit of the plurality of decoder circuits corresponding to the third camera from the initial value to a low speed value, wherein the third camera is not in a predetermined positional relationship with the first camera.

9. The AI inference system according to claim 5, wherein the one or more processors execute the instructions to further:
in response to at least a first camera of the plurality of cameras outputting an image whose confidence value based on the first inference processing exceeds the predetermined threshold, maintain a frame rate of each of a second encoder circuit of the plurality of encoder circuits and a second decoder circuit of the plurality of the decoder circuits at an initial value, wherein the second encoder circuit and the second decoder circuit correspond to a second camera of the plurality of cameras, and wherein the second camera is in a predetermined positional relationship with the first camera.

10. The AI inference system according to claim 9, wherein the one or more processors execute the instructions to further:
in response to a third camera of the plurality of cameras outputting an image whose confidence value based on the first inference processing is equal to or less than the predetermined threshold and the first camera outputting the image whose confidence value based on the first inference processing exceeds the predetermined threshold, reduce a frame rate of each of a third encoder circuit of the plurality of encoder circuits and a fourth decoder circuit of the plurality of decoder circuits corresponding to the third camera from the initial value to a low speed value, wherein the third camera is not in a predetermined positional relationship with the first camera.

11. The AI inference system according to claim 4, wherein the first inference processing executes person detection inference.

12. The AI inference system according to claim 11, wherein the second inference processing executes face recognition inference.

13. A method comprising:
encoding, by an encoder circuit, an image captured by a camera to generate an encoded image;
decoding, a decoder circuit, the encoded image to generate a decoded image;
executing first inference processing on each frame of the decoded image;
generating a respective confidence value for each frame of the decoded image based on the first inference processing;
for each frame of the decoded image, in response to the respective confidence value of a corresponding frame of the decoded image exceeding a predetermined threshold, executing second inference processing with higher accuracy than the first inference on the corresponding frame of the decoded image; and
in response to the respective confidence value of each frame of the decoded image being equal to or less than the predetermined threshold, reducing a frame rate of each of the encoder circuit and the decoder circuit from an initial value to a low speed value.

14. The method according to claim 13, wherein the camera is one of a plurality of cameras, the encoder circuit is one of a plurality of encoder circuits, the decoder circuit is one of a plurality of decoder circuits, and each of the plurality of encoder circuits and each of the plurality of decoder circuits corresponds to one of the plurality of cameras.

15. The method according to claim 14, further comprising:
in response to a first camera of a plurality of cameras outputting an image whose confidence value based on the first inference processing is equal to or less than the predetermined threshold, reducing a frame rate of each of a first encoder circuit of the plurality of encoder circuits and a first decoder circuit of the plurality of decoder circuits corresponding to the first camera from an initial value to a low speed value.

16. The method according to claim 15, further comprising:
in response to at least the first camera outputting an image whose confidence value based on the first inference processing exceeds the predetermined threshold, maintaining a frame rate of each of a second encoder circuit of the plurality of encoder circuits and a second decoder circuit of the plurality of the decoder circuits at an initial value, wherein the second encoder circuit and the second decoder circuit correspond to a second camera of the plurality of cameras, and wherein the second camera is in a predetermined positional relationship with the first camera.

17. The method according to claim 16, further comprising:
in response to a third camera of the plurality of cameras outputting an image whose confidence value based on the first inference processing is equal to or less than the predetermined threshold and the first camera outputting the image based on the first inference processing whose confidence value exceeds the predetermined threshold, reduce a frame rate of each of a third encoder circuit of the plurality of encoder circuits and a fourth decoder circuit of the plurality of decoder circuits corresponding to the third camera from the initial value to a low speed value, wherein the third camera is not in a predetermined positional relationship with the first camera.

18. The method according to claim 14, further comprising:
in response to at least a first camera of the plurality of cameras outputting an image whose confidence value based on the first inference processing exceeds the predetermined threshold, maintain a frame rate of each of a second encoder circuit of the plurality of encoder circuits and a second decoder circuit of the plurality of the decoder circuits at an initial value, wherein the second encoder circuit and the second decoder circuit correspond to a second camera of the plurality of cameras, and wherein the second camera is in a predetermined positional relationship with the first camera.

19. The method according to claim 18, further comprising:
in response to a third camera of the plurality of cameras outputting an image whose confidence value based on the first inference processing is equal to or less than the predetermined threshold and the first camera outputting the image whose confidence value based on the first inference processing exceeds the predetermined threshold, reduce a frame rate of each of a third encoder circuit of the plurality of encoder circuits and a fourth decoder circuit of the plurality of decoder circuits corresponding to the third camera from the initial value to a low speed value, wherein the third camera is not in a predetermined positional relationship with the first camera.

20. The method according to claim 13, wherein the first inference processing executes person detection inference.

21. The method according to claim 20, wherein the second inference processing executes face recognition inference.
